(19) United States
(12) Patent Application Publication
(10) Pub. No.: US 2019/0165625 A1
(43) Pub. Date: May 30, 2019

(54) ROTOR FOR AN ELECTRIC MACHINE AND ELECTRIC MACHINE

(71) Applicant: FEAAM GmbH, Neubiberg (DE)

(72) Inventor: Gurakuq DAJAKU, Neubiberg (DE)

(21) Appl. No.: 16/320,996

(22) PCT Filed: Jul. 27, 2017
(86) PCT No.: PCT/EP2017/069042

§ 371 Date: Jan. 25, 2019

(30) Foreign Application Priority Data
Aug. 3, 2016 (DE) 10 2016 114 362.6

(51) Int. Cl. H02K 1/24; H02K 1/27; H02K 1/28

(52) U.S. Cl. CPC H02K 1/246; H02K 1/28; H02K 1/278; H02K 1/276

(57) ABSTRACT

The invention relates to a rotor (3) for an electric machine (1), the rotor having a rotor core (4), a permanent magnet (5) and a holding means (9, 12), wherein the holding means (9, 12) is connected in a form-locking manner to the rotor core (4) and the permanent magnet (5) is held on the rotor core (4) by means of the holding means (9, 12). The invention further relates to a further rotor (3) and an electric machine (1).

The present invention relates to rotors for an electric machine. Furthermore, the invention relates to an electric machine having such a rotor.

Typically, electric machines comprise a stator and a rotor relatively movable thereto. Electric machines can operate by motor or generator, wherein electrical energy is converted into kinetic energy or vice versa. In electric machines, a distinction is made between different types, for example, synchronous machines or asynchronous machines.

For example, there are synchronous machines that have rotors equipped with permanent magnets. In this case, one typically finds two different, essential rotor topologies, wherein the permanent magnets are either arranged as embedded permanent magnets within a rotor core or are mounted from the outside on the rotor core (surface-mounted permanent magnets).

In the case of surface-mounted permanent magnets, a sheath, or binding, is typically required for fixing the magnets, which additionally protects against occurring centrifugal forces, in particular at high rotor speeds. However, the binding increases an effective air gap between the magnets and a stator surrounding the rotor. As a result, for example, a maximum torque of the electric machine and its efficiency are reduced.

In machines with embedded magnets, in which a variety of topologies exist, “iron bridges” (connecting sections of grooved regions of the rotor core) are typically provided, which provide mechanical stability for the rotor. The thicker these iron bridges, the more advantageous this affects a mechanical stability of the rotor. However, the thickness of the bridges negatively affects electromagnetic performance of the machine, such as the efficiency. In particular, so-called leakage fluxes can occur more intensively, wherein main magnetic fluxes are weakened. Leakage fluxes cause torque losses of the electric machine, for example.

Iron bridges are also provided in synchronous reluctance machines, which typically have a plurality of air-filled magnetic barriers of various characteristics, in order to ensure the mechanical stability of the rotors. Analogously to the above, however, these impair the electromagnetic performance of the machine.

An object underlying the present invention is to specify a concept for rotors for electric machines, which in particular contributes to a mechanical stability of the rotor while simultaneously improving electromagnetic properties of the machine, such as torque density and/or torque efficiency.

The concept is based on the idea of improving the mechanical stability of the rotors in that at least one holding means is provided, which is connected in a form-locking manner to the rotor core and thereby, depending on the type of electric machine, either contributes to holding or attaching a permanent magnet in a form-locking manner on the rotor and/or connects in a form-locking manner two rotor regions which are separated by a groove or an air gap. High mechanical robustness or strength is achieved due to the form-locking, mechanical connection. The holding means is, for example, a stiffening, mechanical bridge. In other words, it is a stiffening means. In particular, for stability reasons, for example, it is possible to supplement or even replace conventionally necessary iron bridges by one or more holding means. On the other hand, it is also possible, for example, to dispense with the binding mentioned above.

According to one aspect, a rotor for an electric machine is disclosed which includes a rotor core, a permanent magnet, and a holding means. The holding means is connected in a form-locking manner to the rotor core and the permanent magnet is held on the rotor core by means of the holding means.

In other words, the permanent magnet is connected in a form-locking manner to the rotor core by interaction of the holding means with the rotor core or held on this. This contributes to increasing a mechanical stability of the rotor. Furthermore, it contributes to keeping the permanent magnet mechanically secure and stable. For example, this makes it possible to avoid iron bridges or to design particularly small, whereby magnetic leakage fluxes can be avoided or at least reduced.

“Holding” is understood to mean that the permanent magnet is held in a form-fitting manner, at least with respect to one direction, for example, in the radial direction with respect to a rotor rotational axis. The form-locking connection is preferably formed such that at least two degrees of freedom of a relative movement between the permanent magnet and the rotor core are prevented. For example, the form-locking connection is formed such that at least one undercut of the elements engaging with one another for the form-locking engagement is present. In other words, the rotor core and the holding means each have a form-locking or counter-form-locking element, which are matched or adapted to each other in terms of their shapes to form the form-locking engagement. The rotor core is typically an iron core or comprises iron material.

According to one embodiment, the form-locking connection of the holding means has a dovetail connection with the rotor core. In other words, the holding means is connected to the rotor core via a dovetail connection or forms a dovetail connection. For example, the rotor core and the holding means have correspondingly matched shapes.

According to one embodiment, the holding means is part of the permanent magnet. In other words, the holding means is formed directly on the permanent magnet or the permanent magnet is formed integrally with the holding means. This achieves a direct mechanical connection of the magnet to the rotor core. This significantly increases the mechanical stability of the rotor, in particular at high rotational speeds. For example, the binding with externally mounted magnet can be dispensed with. On the other hand, it is possible, for example, to attach embedded magnets particularly close to an outside of the rotor and, for example, to realize particularly thin iron bridges to an edge or to other magnets. It is also conceivable to dispense with one or more iron bridges.

According to a further embodiment, the permanent magnet has a further holding means, which is connected via a form-locking engagement to the rotor core. For example, the two holding means are formed integrally with the permanent magnet, such as arranged on opposite sides. As a result, for example, two regions of the rotor core can be connected via the permanent magnet and its form-locking connection via the holding means. This also contributes to realizing particularly thin iron bridges or to dispense with them altogether.

For example, the permanent magnet is arranged substantially tangentially embedded within the rotor core, wherein a holding means is arranged on a side of the magnet facing the rotor rotational axis and the further holding means is arranged on a side of the permanent magnet facing away from the rotor rotational axis. This enables the aforementioned advantages and functions.

According to one embodiment, the holding means is a holding element separate from the permanent magnet. This enables an indirect, form-locking connection of the permanent magnet with the rotor core. For example, the permanent magnet is held on the rotor by means of the holding element. For example, the holding element is arranged on one side of the permanent magnet in a form-locking manner, such as laterally with a magnet mounted outside. For example, the holding element is arranged on a side facing away from the rotor rotational axis of a embedded permanent magnet within the rotor core. Such an arrangement of the holding element is advantageous, for example, in a radially arranged embedded permanent magnet. Optionally, the holding element is set up to provide a stiffening of the rotor or the rotor core.

According to a further embodiment, a further holding means is provided as a holding element separate from the permanent magnet, wherein the permanent magnet is held in a form-locking manner on the rotor core via the two holding elements. In particular, the permanent magnet is arranged between two holding elements, in particular touching or form-locking. Additionally or alternatively, the permanent magnet is clamped between the two holding elements.

According to a further embodiment, a separate holding element is set up and/or arranged in the rotor core such that two separate regions of the rotor core are connected in a form-locking manner. For example, a separate holding element replaces an iron bridge and/or connects the two regions of the rotor core in a form-locking manner, wherein, in addition, it also can serve to hold the permanent magnet to the rotor core in a form-locking manner. The separated regions are regions of the rotor core that are separated with respect to a radial direction starting from the rotor rotational axis, such as through air-filled grooves. In other words, the holding element additionally causes a stiffening of the rotor or of the rotor core. The holding means represents, for example, a stiffening, mechanical bridge. In other words, it is a stiffening means.

According to one embodiment, a separate holding element has a non-magnetic or non-magnetizable material. For example, a separate holding element is manufactured from a ceramic material, a plastic material or aluminum material.

According to one embodiment, a holding means has a groove or a projection and the rotor core has a corresponding counter-holding means, which has a shape for the form-locking engagement, which is formed complementary to the holding means. Thus, a groove-projection or tongue and groove connection or the above-mentioned dovetail connection can be produced.

According to one embodiment, the permanent magnet is arranged on an outer side of the rotor core or embedded within the rotor core. Burying means, for example, that a magnet is arranged in a pocket, groove, recess or notch of the rotor core. The advantages and functions mentioned are enabled, for example, with such topologies.

According to a second aspect, a rotor for an electric machine is disclosed, which has a rotor core having at least one recess, which is formed as a magnetic flux barrier. For example, the recess is formed as a pocket or groove, which is filled with air as a magnetic flux obstruction. The rotor further has a holding means, which is formed as a holding element separate from the rotor core, wherein the holding means is arranged in a form-locking manner on the rotor core in the recess, so that two regions of the rotor core separated by the recess are connected by the holding means. The rotor is, for example, a reluctance rotor. The two regions of the rotor core may also be referred to as layers, sheets, or sections of the rotor core and are arranged in particular with respect to a radial direction with respect to a rotor rotational axis of the rotor.

The holding element and the connection of the separate regions particularly increases the mechanical stability of the rotor. In particular, the holding means can replace, for example, iron bridges that would otherwise have been necessary. The holding means is, for example, a stiffening, mechanical bridge. In other words, it is a stiffening means.

According to one embodiment, the holding means completely fills the recess. Filling in at least refers to a plane normal to a rotor rotational axis. As a result, the magnetic properties, an efficiency of the machine and above all the mechanical robustness can be significantly improved.

According to another aspect, an electric machine is disclosed having a rotor according to any of the previously described embodiments, further having a stator, wherein the rotor is movable relative to the stator. The electric machine enables the aforementioned advantages and functions.

Further advantages and functions are disclosed in the subclaims and in the following detailed description of embodiments.

The embodiments are described below with the aid of the appended figures. Similar or equivalent elements are provided across the figures with the same reference numerals. For reasons of clarity, not all features shown and already described are always provided with a reference numeral.

The figures show:

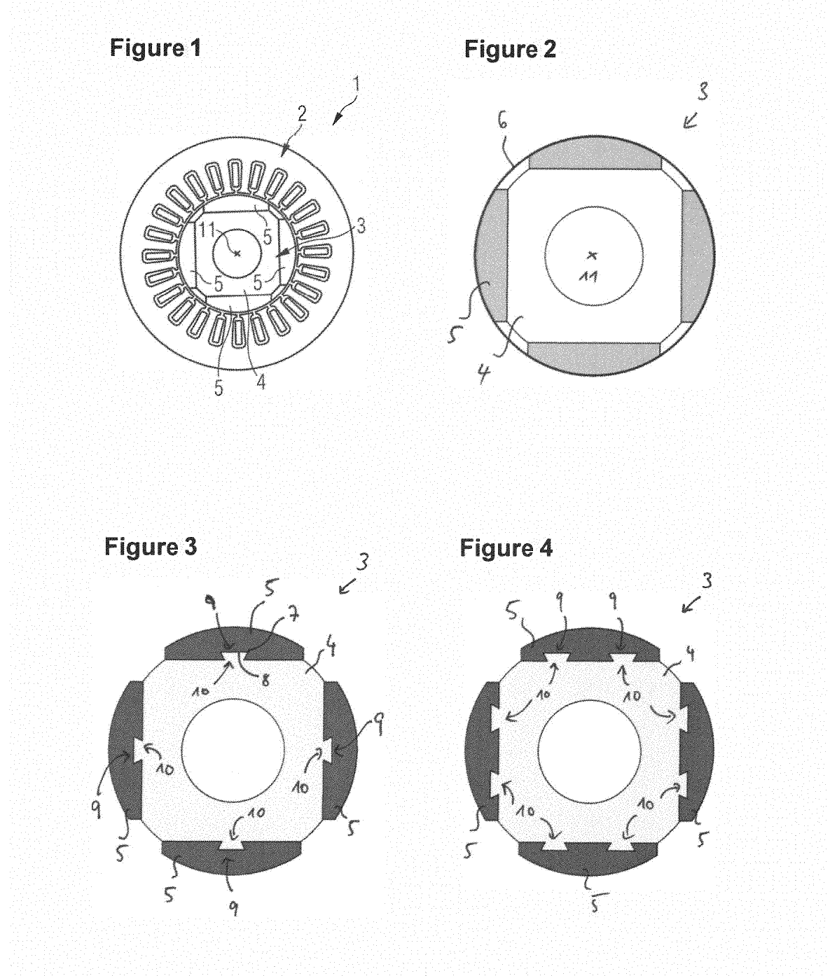

FIGS. 1 and 2 an electric machine and a rotor for the electric machine having surface magnets,

FIGS. 3 to 6 different schematic views of rotors having externally mounted permanent magnets according to embodiments of the invention,

FIGS. 7 and 8 a further electric machine and a rotor for the electric machine having tangentially embedded magnets,

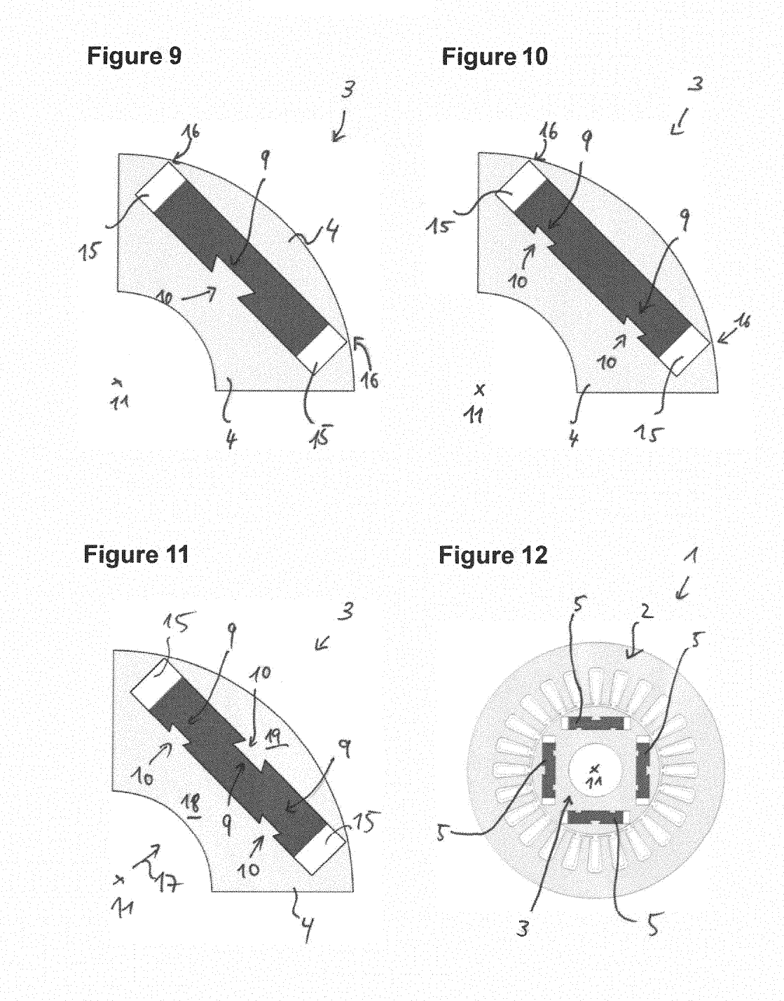

FIGS. 9 to 11 schematic partial views of rotors according to various further embodiments,

FIG. 12 an electric machine having a rotor according to the embodiment according to FIG. 11,

FIG. 13 schematic view of the rotor of the electric machine according to FIG. 12,

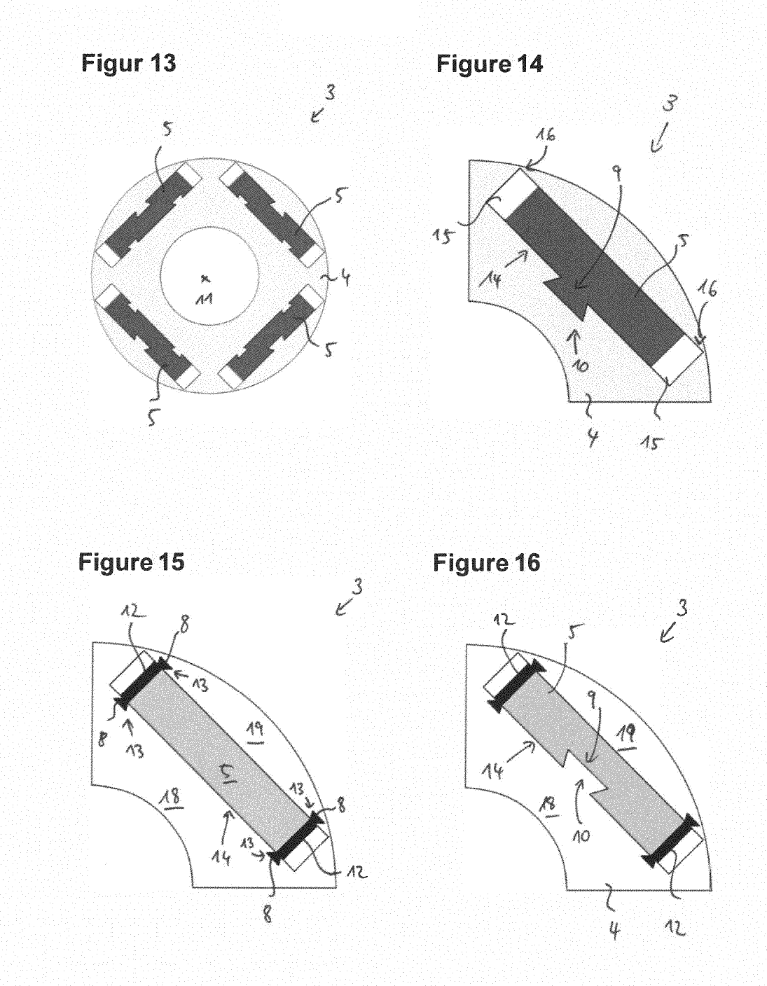

FIGS. 14 to 17 schematic partial views of rotors of various further embodiments,

FIGS. 18 and 19 an electric machine and a rotor for the electric machine having V-shaped embedded magnets,

FIGS. 20 to 24 schematic partial views of rotors according to various further embodiments,

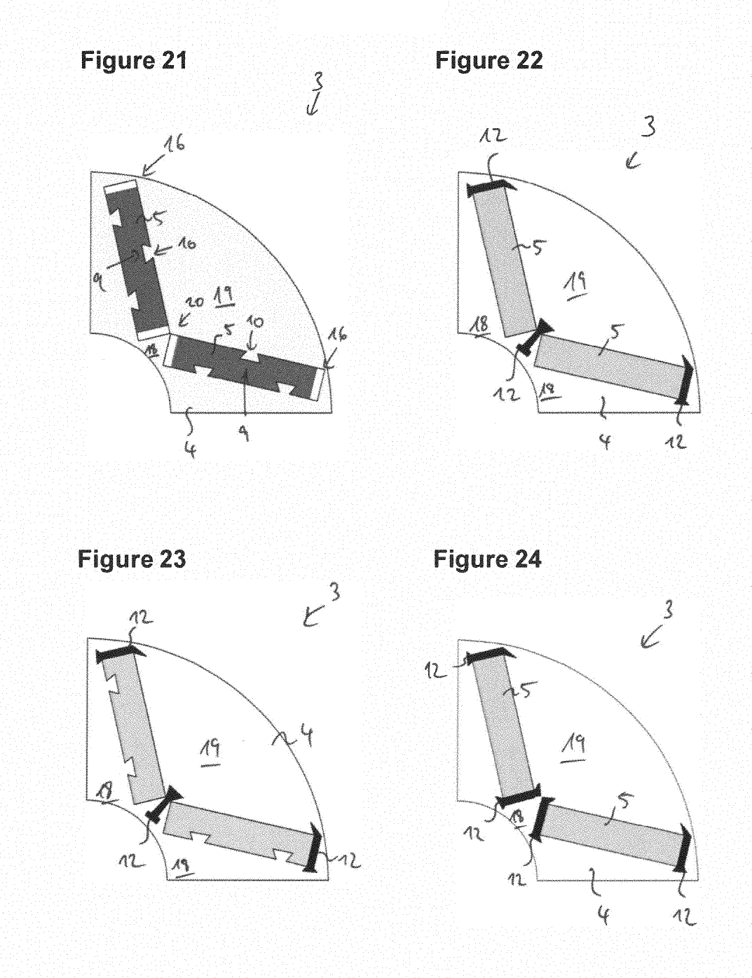

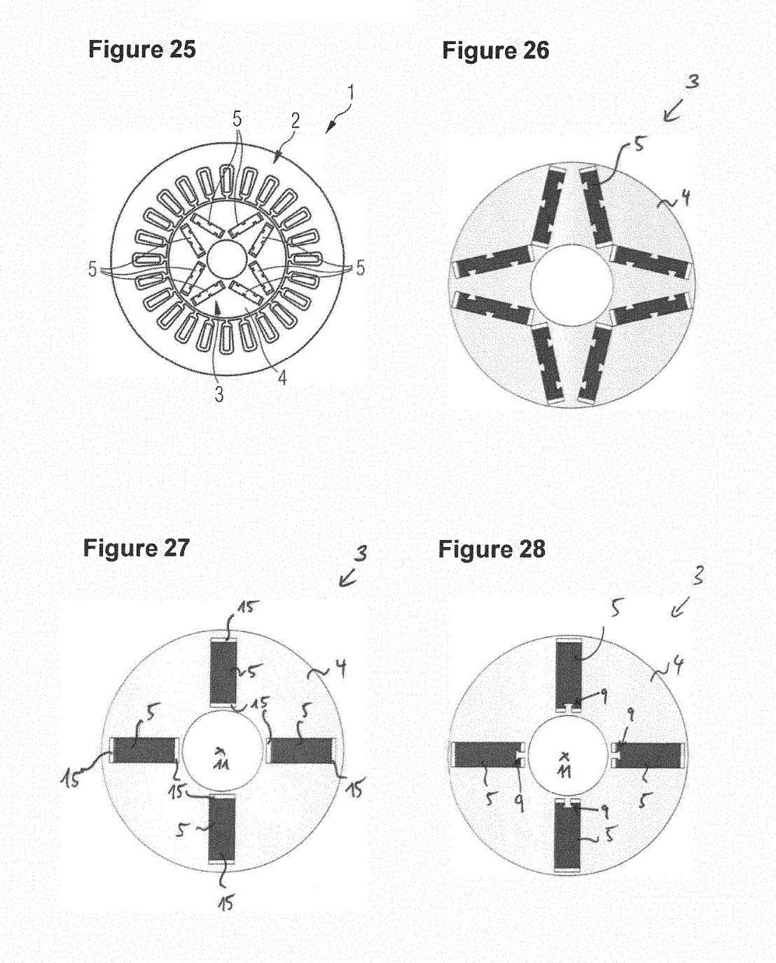

FIGS. 25 and 26 an electric machine and rotor according to the embodiment according to FIG. 21,

FIG. 27 a rotor having radially embedded permanent magnets,

FIGS. 28 to 30 three schematic partial views of rotors having a radial arrangement of permanent magnets according to various further embodiments,

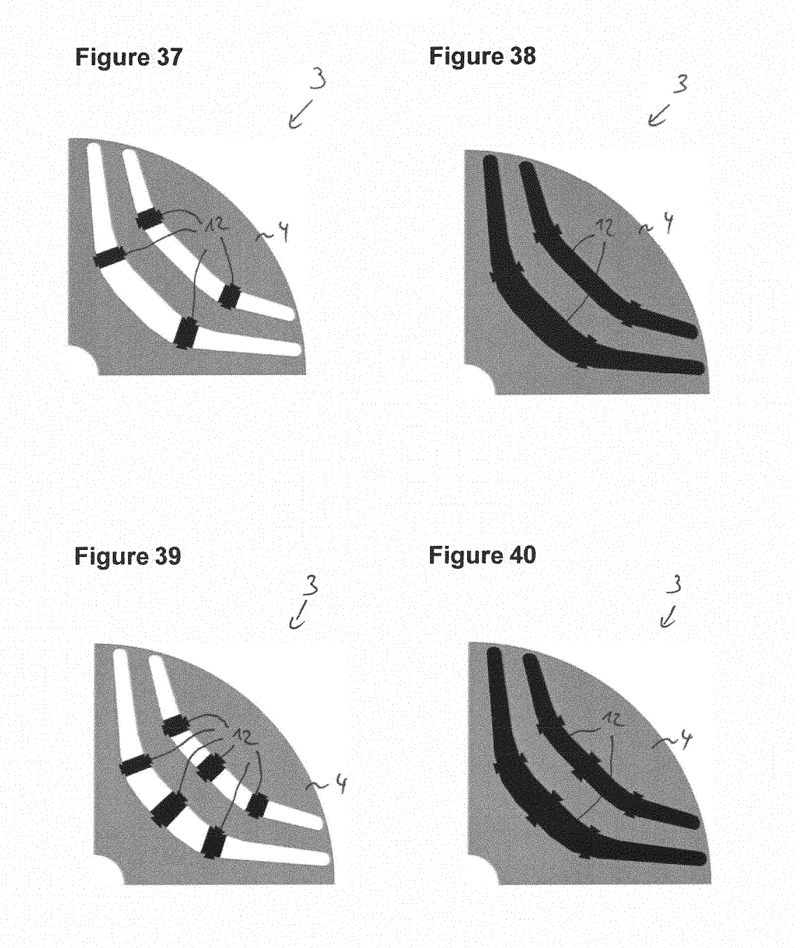

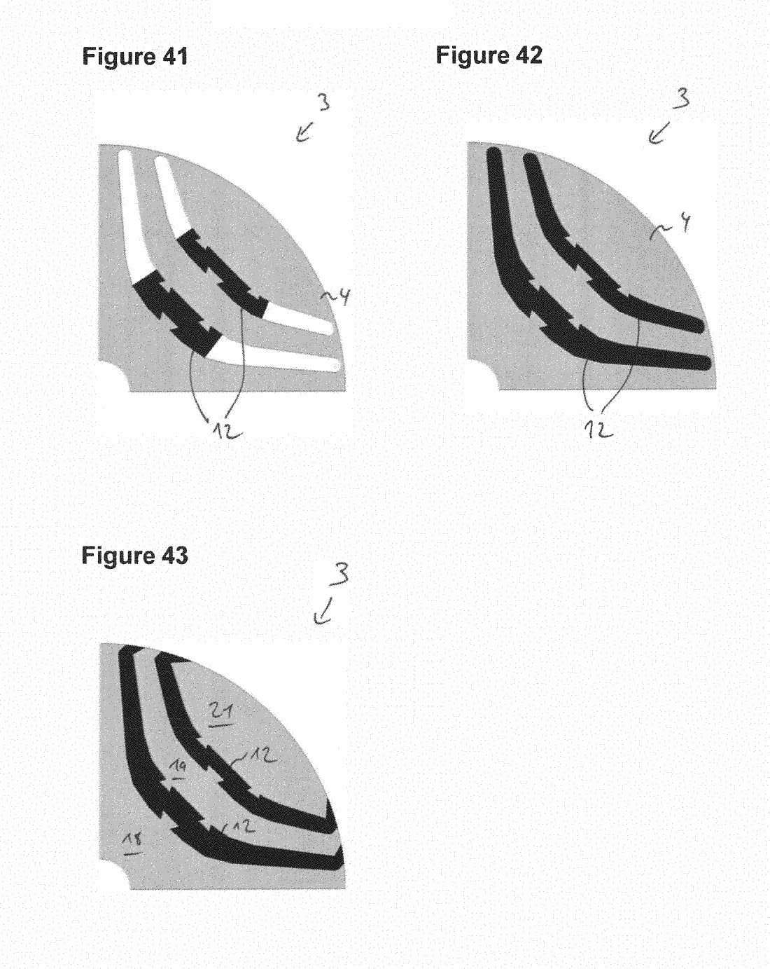

FIGS. 31 to 43 schematic (partial) views of reluctance rotors according to various further embodiments.

FIG. 1 shows schematically an embodiment of an electric (synchronous) machine 1 having a stator 2 and a rotor 3. FIG. 2 shows the rotor 3 without the stator 2. The rotor 3 is rotatable relative to the stator 2 with respect to a rotor rotational axis 11. The electric machine 1 is designed as a synchronous machine. The rotor 3 has a rotor core 4, which is formed as an iron core, and four externally mounted (also called surface-mounted) permanent magnets 5.

The electric machine 1 has four magnetic poles according to the number and arrangement of the permanent magnets 5. The permanent magnets 5 are fixed or held on the rotor core 4 by means of a binding 6.

FIGS. 3 to 6 show various views of rotors 3 according to various embodiments, which are based on the rotor topology shown in FIG. 2.

According to FIG. 3, each permanent magnet 5 is mechanically connected directly to the rotor core 4 via a form-locking connection. For this purpose, each permanent magnet 5 has a first holding means 9, which interacts mechanically with a corresponding first counter-holding means of the rotor core 4. The first holding means 9 has a groove 7, while the first counter-holding means 10 has a projection 8 which engages in the respective groove 7. In other words, each first holding means 9 can be seen as a section or part of the respective permanent magnet 5, which has a shape for forming the groove 7. In contrast, the rotor core 4 has the first counter-holding means 10, which has corresponding shapes for forming the projections 8. In other words, each first holding means 9 is formed as a groove 7 and each first counter-holding means 10 is a projection. 8 The grooves 7 are adapted in terms of their shapes to the projections 8 so that they can engage in a form-locking manner with each other. According to FIG. 3, the permanent magnets are each mechanically connected in a form-locking manner according to a dovetail connection. In the connected state, at least two (translational) degrees of freedom are prevented by the configuration of the form-locking engagement.

It is applicable here and in the following that a first holding means 9 can be seen as a holding means as mentioned above. Furthermore, it is applicable that a first counter-holding means 10 can be seen as a counter-holding means as mentioned above.

This embodiment enables the advantages and functions mentioned above. In particular, an efficiency of an electric machine having such a rotor 3 is improved, since the binding 6 guided externally around the magnets 5 can be dispensed with. As a result, the effective air gap between stator 2 and rotor 3 is reduced. Furthermore, the magnets 5 are mechanically held particularly secure on the rotor core 4. This contributes to a mechanical stability of the rotor 3.

The embodiment shown in FIG. 4 differs with respect to the rotor shown in FIG. 3 in that the number of first holding means 9 or first counter-holding means 10 is doubled. This increases the mechanical safety and robustness of the rotor 3.

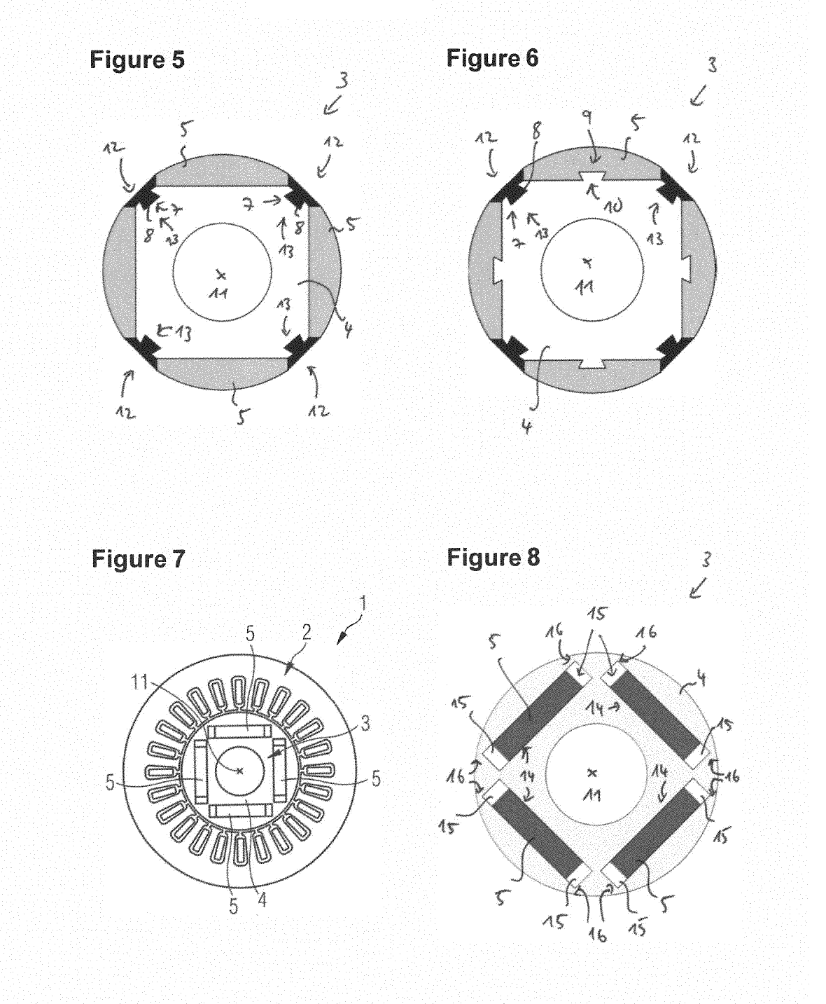

FIG. 5 shows a further embodiment, wherein the permanent magnets 5 do not themselves have a holding means. Rather, in each case, a second holding means 12 are provided in intermediate regions of two poles between two permanent magnets 5, which is formed as a holding element separate from the magnet 5. A separate holding element can also be referred to as a fixing element. Each second holding means 12 has a projection 8 for interacting with a corresponding second counter-holding means 13 of the rotor core 4, wherein the further counter-holding means 13 has a groove 7.

The interaction of second holding means 12 and second counter-holding means 13 is analogous to above, wherein, in turn, a form-locking engagement is present in the manner of a dovetail connection. The second holding means 12 are formed so that each two of them hold a permanent magnet 5 on the rotor core 4 in a form-locking manner. In this respect, the permanent magnets 5 are held indirectly on the rotor core 4 in a form-locking manner by means of the second holding means 12. This embodiment also enables the mentioned advantages of a particularly secure mechanical coupling of the permanent magnets 5 to the rotor core, wherein the effective air gap to the stator 2 can be reduced.

The separate holding elements 12 are made of a non-magnetic material, such as a ceramic material, plastic material or aluminum material. The holding elements contribute to avoiding magnetic leakage fluxes, in particular between the magnetic poles.

It is applicable here and in the following that a second holding means 12 can be seen as a holding means as mentioned above. Furthermore, it is applicable that a second counter-holding means 13 can also be seen as a counter-holding means as mentioned above.

FIG. 6 shows a further embodiment, wherein the embodiments according to FIGS. 3 and 5 are combined. As a result, the permanent magnets 5 have integral first holding means 9 which interact with corresponding first holding means 10 of the rotor core 4. In addition, second holding means 12 and second counter-holding means 13 are provided.

It should be mentioned at this point that here and in the following, the interaction of the projections 8 with the grooves 7 can also be carried out selectively reversed.

For example, one or all of the permanent magnets 5 according to FIG. 3 can have a projection 8 which interacts with grooves 7 introduced into the rotor core 4. Likewise, the form-locking engagement with the holding means can also be achieved via other geometric shapes.

FIG. 7 schematically shows a further electric machine 1 having a stator 2 and a rotor 3, which differs in the rotor topology from the previously described embodiments. FIG. 8 shows the rotor 3 without the stator 2. The electric machine 1 is designed as a synchronous machine having permanent magnets 5. The permanent magnets 5 are embedded within the rotor core 4, arranged substantially tangentially. The electric machine 1 has four magnetic poles according to the number and arrangement of the permanent magnets 5.

The permanent magnets 5 are arranged in recesses 14 within the iron rotor core 4, wherein magnetic flux barriers 15 connect at laterally opposite ends, which barriers are realized as air-filled cavities. A stability of the rotor 3 is ensured via so-called iron bridges 16, which define a thinnest region of the rotor core 4 between an outer side and the magnetic flux barriers 15 or define the recesses 14.

FIGS. 9 to 11 show partial views of rotors 3 according to further embodiments. This is shown here as well as in the following partial views of one of four equal quarters of a rotor 3, which corresponds to a magnetic pole of the rotor 3.

Analogously to the above, the permanent magnets 5 shown in FIGS. 9 to 11 have one or more first holding means 9, which have grooves 7. As above, a form-locking engagement to the rotor core 4 is achieved by means of dovetail connection. Due to the form-locking engagement and the obtained mechanical stability of the rotor 3, in particular, the iron bridges 16 can be made particularly thin. As a result, above all, magnetic leakage flux at the lateral edges of the magnets 5 can be significantly reduced, which contributes to a higher efficiency of an electric machine.

It should be emphasized in the embodiment according to FIG. 11, that by providing first holding means 9 on two opposite sides of a permanent magnet 5 with respect to a radial direction 17 starting from the rotor rotational axis 11, a first region 18 and a second region 19 of the rotor core 4, which are separated by the recess 14 and thus a permanent magnet 5, are mechanically connected. This contributes significantly to the mechanical strength of the rotor 3, in particular at high rotor speeds in operation.

FIGS. 12 and 13 show an electric machine 1 having a completely illustrated rotor 3 according to FIG. 11.

FIG. 14 shows a partial view of a rotor 3 according to a further embodiment, wherein, in contrast to FIG. 9, the configuration of the first holding means 9 and the first counter-holding means 10 is strained.

FIGS. 15 to 17 show further embodiments of rotors 3. These rotors 3 also enable the advantages and functions already mentioned.

In FIG. 15, similar to FIG. 5, second holding means 12 are provided, which are formed separately from the permanent magnets 5. These have, for example, as above, a non-magnetic material and are arranged in a form-locking manner on opposite narrow sides (lateral sides) of a permanent magnet 5 connected to the rotor core 4. As already described with regard to FIG. 11, the second holding means 12 each connect two regions 18, 19 of the rotor core 4, wherein each second holding means 12 each has two opposite projections 8, which interact in a form-locking manner with second counter-holding means 13 of the rotor core 4. The permanent magnet 5 is arranged between the two second holding means 12 and held in a form-locking manner, for example, clamped. Furthermore, the second holding means 12 contribute to the fact that each permanent magnet 5 is held in a form-locking manner on the rotor core 4 in order, for example, to better receive centrifugal forces during operation, in particular at high rotational speeds of the rotor 3.

The separate holding elements 12 stiffen the rotor 3.

It should be mentioned at this point that a holding means 12 also have two grooves 7 or a respective groove 7 or a projection 8 or may be formed accordingly.

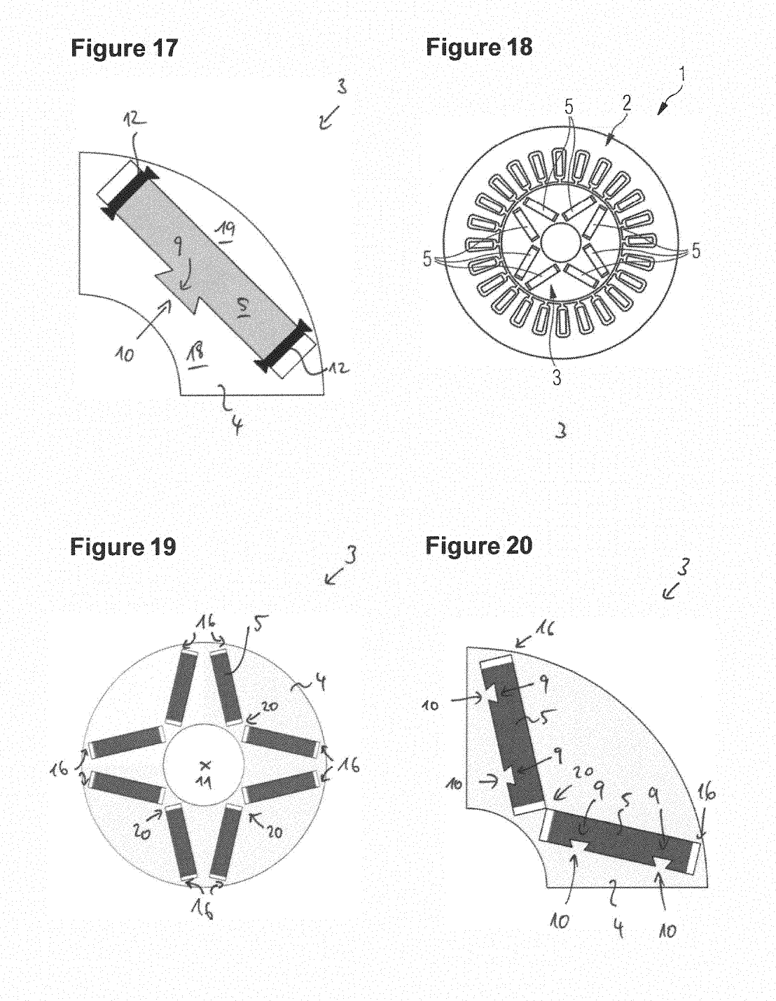

FIGS. 16 and 17 show further embodiments of rotors 3, which are formed similar to the rotor 3 of FIG. 6, wherein, in addition to second holding means 12 and second counter-holding means 13, first holding means 9 and first counter-holding means 10 are also provided, so that a direct form-locking engagement the permanent magnet 5 is accomplished with the rotor core 4.

The described embodiments according to FIGS. 9 to 17 can also be transferred to further rotor topologies for rotors having embedded permanent magnets. In addition to the described, tangentially arranged magnets, the described solutions can also be implemented in rotors having V-shaped permanent magnets or radially arranged permanent magnets (so-called spoke magnets), as described below.

For example, in FIGS. 18 and 19, an electric machine 1 and a rotor 3 are shown having permanent magnets 5 arranged in a V-shape. In this case, two magnets 5 which are arranged in a V-shape and form an outwardly open “V” always represent a magnetic pole of the rotor 3. Iron bridges 16 are located towards the outer edge of the rotor 3 analogously as above, wherein further iron bridges 20 are additionally provided in the region of the next distance between two permanent magnets 5 of a magnetic pole.

FIGS. 20 to 23 show embodiments of rotors 3, which have corresponding features, as they have already been described above.

Thus, FIGS. 20 and 21 show rotors 3 in which the permanent magnets 5 themselves have first holding means 9 with grooves 7, which interact in a form-locking manner with first counter-holding means 10 of the rotor cores 4 which have projections 8.

FIGS. 22 to 24 show further embodiments of rotors 3 in the sense of the previously described embodiments, wherein either separate holding elements alone or in combination with first holding means 9 of the permanent magnets 5 are provided.

It applies to the FIGS. 20 to 24, that the iron bridges 16 and the further iron bridges 20 can be significantly reduced due to the novel design, such as thinner, and/or even completely omitted.

FIGS. 25 and 26 show an electric machine 1 and the associated rotor 3 according to the embodiment shown in FIG. 21.

FIG. 27 shows an embodiment of a rotor 3 according to a further rotor topology having embedded magnets, wherein four permanent magnets 5 are arranged radially in the rotor core 4. Magnetic flux barriers 15 are in turn provided, which are formed on a side facing the rotor rotational axis 11 and a side of the permanent magnets 5 facing away from the rotor rotational axis 11.

FIGS. 28 to 30 show further embodiments of rotors 3 having embedded permanent magnets 5 according to the topology shown in FIG. 27, wherein again the features already described with regard to the holding means are resorted to.

In FIG. 28, first holding means 9 are provided on the side of each permanent magnet 5 facing the rotor rotational axis 11, which interact with the rotor core 4 in a form-locking manner in the described manner.

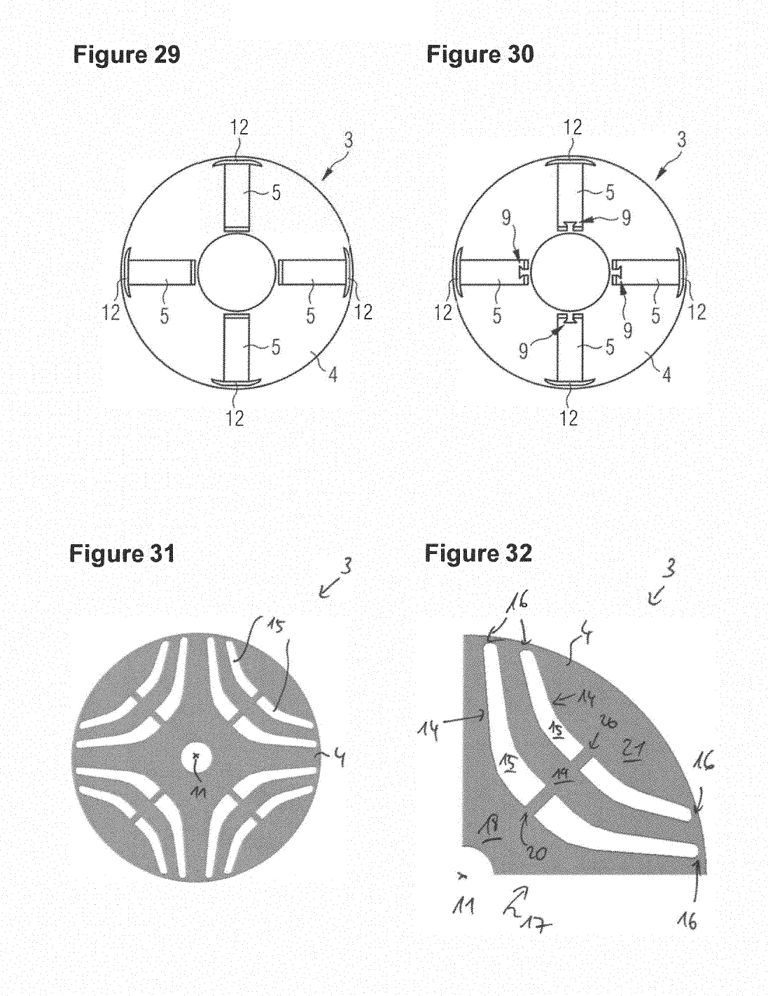

In FIG. 29, second holding means 12 are provided as separate holding elements in the manner described.

FIG. 30 shows an embodiment in which the features of FIGS. 28 and 29 are combined analogously to the above embodiments.

The rotors 3 of FIGS. 28 to 30 enable the advantages and functions described.

FIGS. 31 and 32 show two views of a rotor 3, which is formed as a reluctance rotor. A pure reluctance rotor has no permanent magnets. The reluctance rotor 3 has a rotor iron core 4, in which double V-shaped recesses 14 are introduced as magnetic flux barriers 15 with missing iron. Analogously to above, first iron bridges 16 and second iron bridges 20 are formed, which conventionally provide stability for the rotor 3.

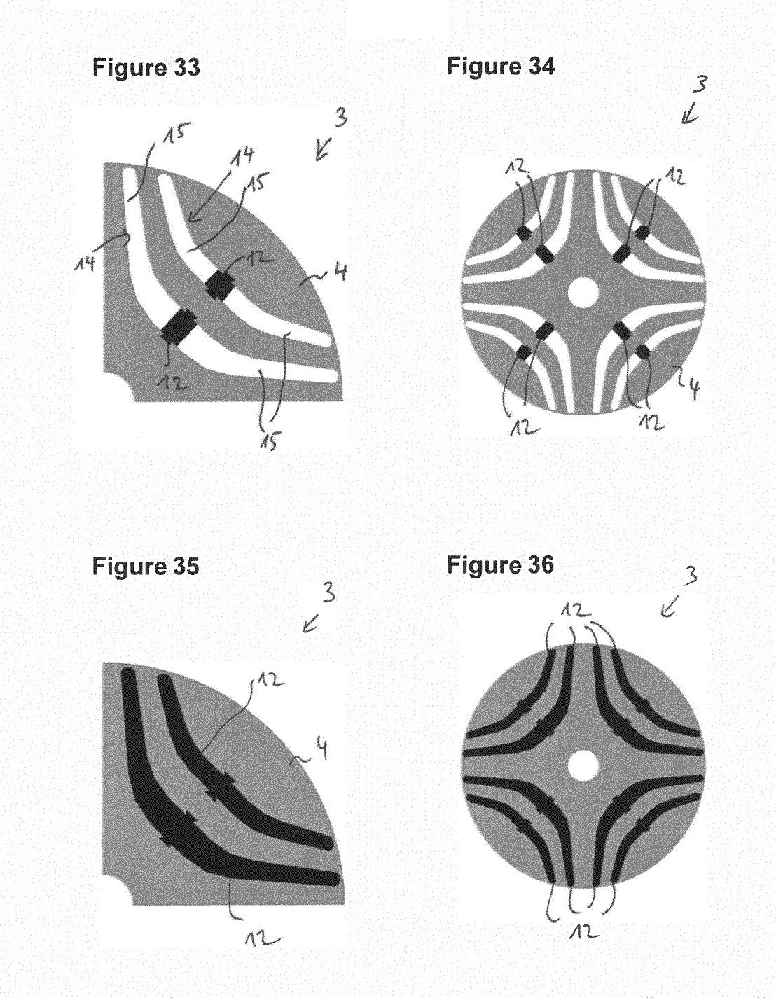

FIGS. 33 to 43 show further embodiments of reluctance rotors 3 according to the principles already described. This is common to the rotors 3, that in the recesses 14 at least a second holding means 12 is inserted as a holding means, which through the recesses 14 connects separate regions 18, 19, 21 of the rotor 3 with respect to the rotor rotational axis 11 with respect to the radial direction 17.

As already described above, the second holding means 12 in this case are in a form-locking engagement with the rotor core 4, in particular with corresponding second counter-holding means 13. In each case, at least the further, second iron bridges 20 are replaced in each of the embodiments shown, while the first iron bridges 16 are at least significantly reduced at the edge of the rotors 3. Furthermore, it is recognizable that the entire recesses 14 are partially filled with second holding means 12. For example, the recesses 14 are partially or completely filled with the second holding means 12 by means of casting methods.

It should be emphasized in the embodiment according to FIG. 43 that the regions 18, 19 and 21 of the rotor core 4 are completely separated from each other, ergo are not connected by iron bridges or other sections of the rotor core 4 or its iron material. Rather, the regions 18, 19 and 21 are in a form-locking manner, mechanically connected exclusively via the holding means 12.

It should be mentioned at this point that the rotor core 4 is formed, for example, by a rotor laminated core and all shapes of the rotor core 4 are made, for example, by punching or corresponding machining of the laminated core.

The general principle common to all described embodiments, is that holding means are provided, which are connected in a form-locking manner to the rotor core. As a result, on the one hand, a mechanical robustness of the rotors is increased without weakening, as mentioned above, magnetic properties and the associated efficiencies of electric machines. Rather, the latter are even improved.

The features of the described and shown embodiments can be combined with each other.

### LIST OF REFERENCE NUMBERS

1 electric machine
2 stator
3 rotor
4 rotor core
5 permanent magnet
6 binding
7 groove
8 projection
9 first holding means
10 first counter-holding means
11 rotor rotational axis
12 second holding means
13 second counter-holding means
14 recess
15 magnetic flux barrier
16 iron bridge
17 radial direction
18 first region
19 second region
20 further iron bridge
21 third region

1. A rotor (3) for an electric machine (1), the rotor having a rotor core (4), a permanent magnet (5) and at least one holding means (9, 12), wherein the holding means (9, 12) is connected in a form-locking manner to the rotor core (4) and the permanent magnet (5) is held on the rotor core (4) by means of the holding means (9, 12).

2. The rotor (3) according to claim 1, wherein the form-locking connection of the holding means (9, 12) to the rotor core (4) has a dovetail connection.

3. The rotor (3) according to claim 1 or 2, wherein the holding means (9) is part of the permanent magnet (5).

4. The rotor (3) according to claim 3, wherein the permanent magnet (5) has at least one further holding means (9), which is connected to the rotor core (4) via a form-locking engagement.

5. The rotor (3) according to claim 1 or 2, wherein the holding means (12) is a holding element separate from the permanent magnet (12).

6. The rotor (3) according to claim 5, wherein a further holding means (12) is provided as a holding element separate from the permanent magnet (5), wherein the permanent magnet (5) is held in a form-locking manner on the rotor core (4) via the two holding elements (12).

7. The rotor (3) according to claim 5, wherein a separate holding element is set up and/or arranged in the rotor core (4) such that two separate regions (18, 19, 21) of the rotor core (4) are connected in a form-locking manner.

8. The rotor (3) according to claim 5, wherein a separate holding element has a non-magnetic or non-magnetizable material.

9. The rotor (3) according to claim 1, wherein a holding means (9, 12) has a groove (7) or a projection (8), and the rotor core (4) has a corresponding counter-holding means (10, 13), which has a shape for the form-locking engagement, which shape is formed complementary to the holding means (9, 12).

10. The rotor (3) according to claim 1, wherein the permanent magnet (5) is arranged on an outer side of the rotor core (4) or embedded within the rotor core (4).

11. A rotor (3) for an electric machine, having a rotor core (4) having at least one recess (14), which is formed as a magnetic flux barrier (15), and at least one holding means (12), which is formed as a separate holding element, wherein the holding means (12) is arranged in a form-locking manner on the rotor core (4) in the recess (14), so that two regions (18, 19, 21) of the rotor core (4) separated by the recess (14) are connected by the holding means (12).

12. The rotor (3) according to claim 11, wherein the holding means (12) completely fills the recess (14).

13. The rotor (3) according to claim 11 or 12, wherein the holding means (12) has two grooves (7), two projections (8) or a projection (8) and a groove (7), and the rotor core (4) has respective corresponding counter-holding means (13), which each have a shape for the form-locking engagement with the holding means (12), which shape is formed complementary to the holding means (12).

14. The rotor (3) according to claim 11, wherein the holding means (12) has a non-magnetic or non-magnetizable material.

15. The rotor (3) according to claim 11, wherein the rotor (3) is formed as a reluctance rotor.

16. An electric machine (1) having a rotor (3) according to claim 1 or 11 and further having a stator (2), wherein the rotor (3) is movable relative to said stator (2).
